(19) United States
(12) Patent Application Publication
(10) Pub. No.: US 2025/0225859 A1
(43) Pub. Date: Jul. 10, 2025

(54) EMERGENCY ALERT SYSTEM WITH WEARABLE DEVICE

(71) Applicant: Dasha Batista, North Salem, NY (US)

(72) Inventor: Dasha Batista, North Salem, NY (US)

(21) Appl. No.: 19/009,875

(22) Filed: Jan. 3, 2025

Related U.S. Application Data
(60) Provisional application No. 63/630,162, filed on Jan. 6, 2024.

(51) Int. Cl. G08B 25/01; G06F 1/16; G06F 3/04817; G06F 21/32; H04W 4/029; H04W 4/90

(52) U.S. Cl. CPC G08B 25/016; G06F 1/163; G06F 3/04817; G06F 21/32; H04W 4/029; H04W 4/90

(57) ABSTRACT

A emergency alert system comprises a wearable device that includes a biometric authentication module to verify user identity, emergency icons for specific services, a location tracking module, and a notification module. Upon activation of an emergency icon, the device contacts the relevant service, provides precise location information, and alerts a predefined group to initiate emergency protocols. The wearable device can be a smartwatch or fitness tracker.

### CROSS-REFERENCE TO RELATED APPLICATIONS

This application claims priority to U.S. Provisional Application Ser. No. 63/630,162, filed Jan. 6, 2024, and which is incorporated by reference in its entirety.

### BACKGROUND

### Field

The present disclosure relates to an emergency alert system and method, and more particularly, to a wearable emergency alert device and its associated technologies.

### Description of the Problem and Related Art

In today's world, the need for effective and rapid emergency response systems is more critical than ever. With the increasing frequency of emergencies ranging from health crises to security threats, there is a pressing demand for innovative solutions that can ensure safety and provide immediate assistance. Traditional methods of contacting emergency services, such as dialing emergency numbers, can be time-consuming and may not always be feasible in high-stress situations. This has led to a growing interest in integrating technology into personal safety devices to enhance the speed and efficiency of emergency responses.

Wearable technology has emerged as a promising avenue for addressing these challenges. By incorporating advanced features such as GPS tracking, biometric authentication, and real-time communication capabilities, wearable devices can offer a seamless and discreet way to alert authorities and loved ones during emergencies. These devices can be particularly beneficial in environments where quick action is essential, such as schools, workplaces, and public venues. As technology continues to evolve, there is a significant opportunity to develop comprehensive security systems that leverage the latest advancements to protect individuals and communities effectively.

### SUMMARY

For purposes of summary, certain aspects, advantages, and novel features are described herein. It is to be understood that not necessarily all such advantages may be achieved in accordance with any one particular embodiment. Thus, the apparatuses or methods claimed may be embodied or carried out in a manner that achieves or optimizes one advantage or group of advantages as taught herein without necessarily achieving other advantages as may be taught or suggested herein.

The security system may include a wearable device that can be worn by a user. The wearable device may have a biometric authentication module that can activate the wearable device after verifying the user's identity. The device may also feature several emergency icons, each linked to a specific emergency service. A location tracking module may determine the precise location of the wearable device, and a notification module can send a confirmation alert to the user when an emergency icon is activated. The wearable device can contact the corresponding emergency service when an emergency icon is activated, provide the precise location to the contacted service, and notify a predefined group of recipients to initiate emergency protocols.

The method for providing emergency assistance may involve the wearable device receiving biometric data from a user and verifying the user's identity based on the data. Upon successful verification, the wearable device can activate several emergency icons, each linked to a specific emergency service. The device may receive a selection of an emergency icon, determine its precise location, contact the emergency service linked to the selected icon, provide the precise location to the contacted service, and notify a predefined group of recipients to initiate emergency protocols.

Some examples of the security system may include a biometric authentication module with a fingerprint scanner. The emergency icons can include a fire icon, a police icon, and a medical icon. The location tracking module may have a Global Positioning System (GPS) receiver. The notification module can send confirmation alerts through visual, auditory, or haptic feedback. The wearable device may also provide the user's emergency contacts to the contacted emergency service and can be a smartwatch or a fitness tracker.

In the method for providing emergency assistance, the biometric data may include a fingerprint. The emergency icons can include a fire icon, a police icon, and a medical icon. Determining the precise location of the wearable device may involve using a Global Positioning System (GPS). The method can also include sending a confirmation alert to the user upon contacting the emergency service, with the alert sent via visual, auditory, or haptic feedback. The wearable device may provide the user's emergency contacts to the contacted emergency service and can be a smartwatch or a fitness tracker.

### BRIEF DESCRIPTION OF THE DRAWINGS

The system is described with reference to the accompanying drawings. In the drawings, like reference numbers indicate identical or functionally similar elements. Additionally, the left-most digit(s) of a reference number identifies the drawing in which the reference number first appears.

FIG. 1 is a functional representation of an exemplary emergency alert system;

FIG. 2 is a functional schematic of a wearable computer-based device; and

FIG. 3 depicts exemplary software modules that may be incorporated into the device memory; and

FIG. 4 illustrates icons that may be rendered on the display of the wearable device.

### DETAILED DESCRIPTION

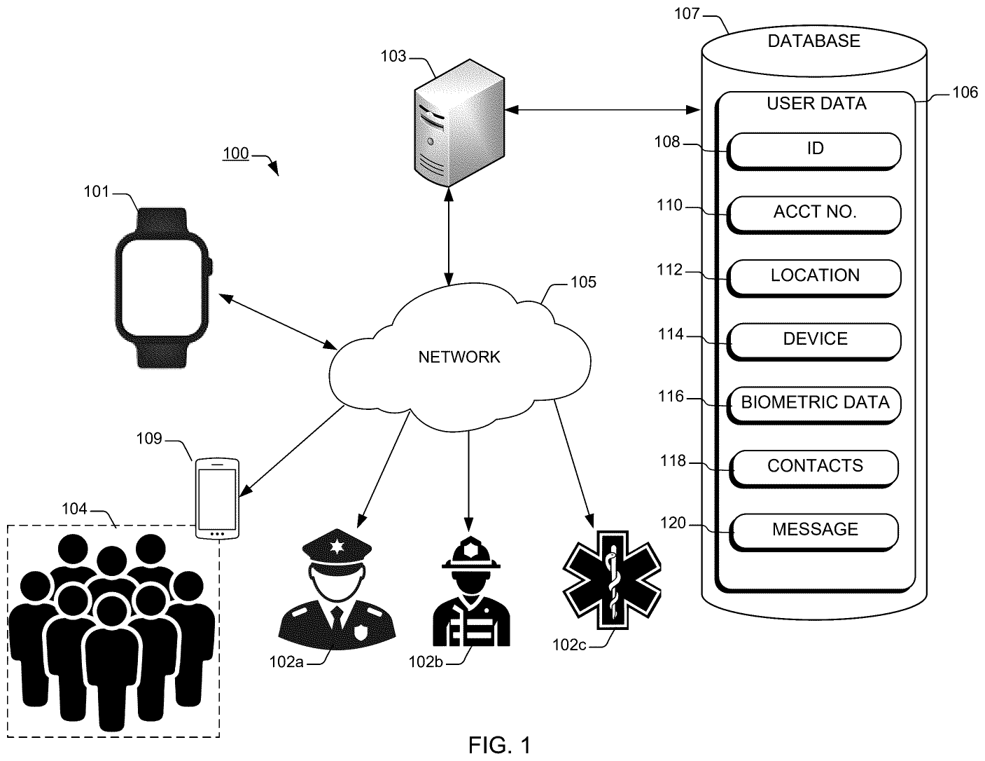

The various embodiments of the emergency alert system and their advantages are best understood by referring to FIGS. 1 through 4 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

With reference to FIG. 1, an exemplary emergency alert system 100 may include a computer-based wearable device 101, which may be a bracelet, a smartwatch or a fitness tracker, and which is described in greater detail hereafter. Wearable device 101 is communication with one or more servers 103 over a network 105, for example, the Internet. Server 103 either comprises or is in communication with a database 107 which is configured to store wearable device's user data 106, which may comprise, for example, user id 108, account number 110, device location 112, device data 114, user biometric data 116, user-identified contacts, and a user-composed emergency message 120.

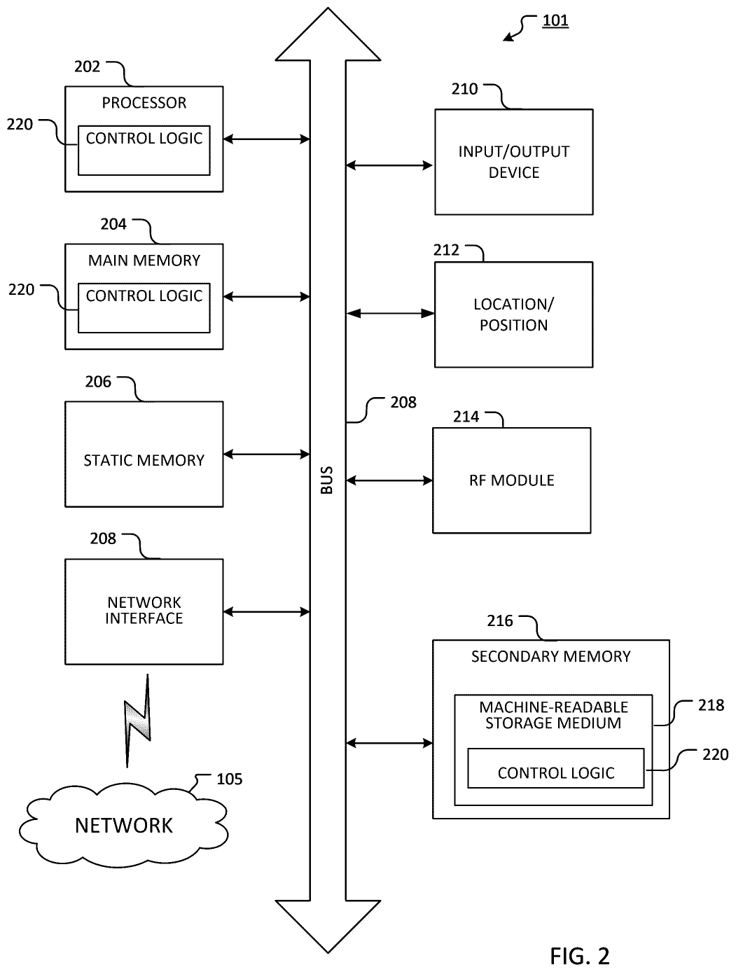

An exemplary computer-based wearable device 101 is functionally illustrated in FIG. 2, wherein the computer comprises one or more processors 202, a main memory 204 (e.g., read-only memory (ROM), flash memory, dynamic random access memory (DRAM) such as synchronous DRAM (SDRAM) or DRAM (RDRAM), etc., and may comprise a static memory 206 (e.g., flash memory, static random access memory (SRAM), etc.), and a secondary memory 216 (e.g., a data storage device), which communicate with each other via a bus 208.

Processor 202 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 202 may also be one or more special-purpose processing devices such as an application specific integrated circuit (ASIC), a field programmable gate array (FPGA), a digital signal processor (DSP), network processor, or the like. Processor 202 is configured to execute the control logic 220 for performing the operations discussed herein.

Device 101 may further include a network interface device 208 for allowing communication with any external networks. Device 101 preferably comprises an input/output device, for example a, display unit 210 which may be light emitting diode (LED), liquid crystal display (LCD), organic light emitting diode (OLED), or the like. Further, input/output device may also be a touch-sensitive screen.

The secondary memory 216 may include a machine-readable storage medium (or more specifically a computer-readable storage medium) 218 on which is stored one or more sets of instructions (e.g., control logic or software 220) embodying any one or more of the methodologies or functions described herein. The software 220 may also reside, completely or at least partially, within the main memory 204 and/or within the processing device 202 during execution thereof by the device 101, the main memory 204 and the processing device 202 also constituting machine-readable storage media. The software 220 may further be transmitted or received over a network 105 via the network interface device 208, or via wireless communications via a radio frequency (RF) communications module 214 which is configured to allow RF communications with devices having compatible communications protocols, e.g., IEEE protocol standards 202.11, 202.15, or the like. Device 101 may also comprise hardware 212 to determine the device's location or position. Such hardware 212 may include a GPS receiver, and wireless positioning, such as cellular network positioning, Wi-Fi Positioning System (WPS), Bluetooth Low Energy (BLE), Near Field Communications (NFC), and Radio Frequency Identification (RFID).

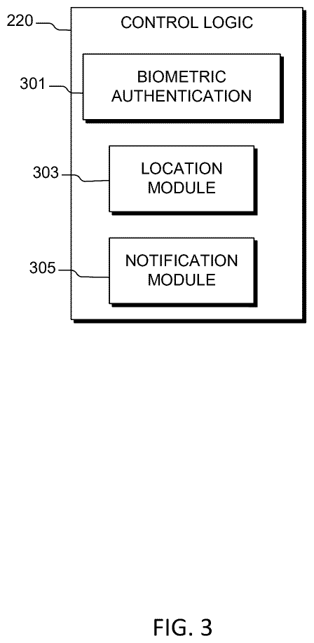

FIG. 3 is a diagram illustrating a wearable device, according to an embodiment. The wearable device 101 may be configured with control logic 220 which may comprise several modules, each serving a distinct function to enhance the security system's capabilities. The biometric authentication module 301 may verify the user's identity through biometric data, such as fingerprints, ensuring that the device is activated only by the rightful owner. A location tracking module 303 may determine the precise location of the wearable device using location and positioning hardware 212.

The notification module 305 may send a confirmation alert to the user upon activation of an emergency icon. This alert may assure the user that the corresponding officials have been notified and that help is on the way. The confirmation may be delivered through an alert which may be visual, auditory or haptic, or any combination thereof, providing the user with peace of mind during an emergency situation.

In operation, when a user finds themselves in an emergency situation, for example, fire, medical emergency, or an active shooter situation, wearable device 101, which may be a bracelet, smartwatch or fitness tracker, can be configured to receive biometric data, potentially in the form of fingerprints, from the user. This biometric data may be utilized to authenticate the user's identity, ensuring that the device 101 is personalized and securely programmed to the owner. Device 101 may be designed to activate only upon successful verification of the user's identity, thereby preventing unauthorized access.

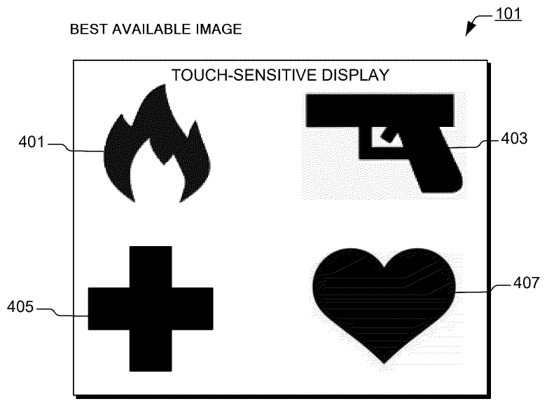

Device 101 then renders a plurality of emergency icons on its input/output device 210, which may be a touch-sensitive display, upon successful verification of the user's identity. The icons, shown in FIG. 4, correspond to different emergency services, such as a fire icon 401, a police/active shooter icon 403, and a medical icon 405. The user may then select an icon appropriate for the emergency situation. The activation of these icons may be silent and efficient, allowing the user to report emergencies without drawing attention.

The system is configured to contact local authorities, such as the fire department 102b, police department 102a, and emergency medical technicians (EMTs) 102c, corresponding to the icon 401, 403, 405 selected, providing the authorities with the user's precise location calculated by the location module 303. The activation of the emergency icons may also trigger a notification to a predefined group of recipients, initiating emergency protocols to ensure safety procedures are followed. Optionally, the device 101 may be configured to render a fourth icon 407, such as a heart icon, that, upon selection, causes the system to issue the user-composed message 120 to the user-defined group of contacts 118 stored in the user data 106. Once the appropriate authorities 102 have been alerted, device 101 is configured to notify the user that the alert has been received by the authorities 102. The notification may be visual, audio, haptic, or any combination thereof.

Sadly, contemplated users include students. The system 100 may also be configured with protocol settings used to prevent students from cheating while taking tests. The system 100 may also be configured to automatically transmit device 101 location data even when the device 101 is not activated. Further, facilities such as office buildings, schools, hospitals, etc., may become “users” and adopt companion applications to which the device 101 is responsive, such the system detects entry or exit. Accordingly, in a school setting, user attendance may be tracked. The application may also be configured to ping another user's device to get their location using the application GPS during an emergency.

Those skilled in the relevant arts will recognize the system should be robust, with the ability to communicated with servers 103 and positioning systems even in cases where reception is lost or there is no WiFi connection to send an emergency message

As described above and shown in the associated drawings, the present invention comprises emergency alert system and method. While particular embodiments have been described, it will be understood, however, that any invention appertaining to the apparatus/system/method described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. An emergency alert system comprising:
a wearable device configured to be worn by a user, the wearable device comprising:
a biometric authentication module configured to activate the wearable device upon verifying the user's identity;
a touch-sensitive display configured to render a plurality of emergency icons, each icon corresponding to a specific emergency service;
a location tracking module configured to determine a precise location of the wearable device; and
wherein the wearable device is further configured to:
contact the corresponding emergency service upon activation of an emergency icon;
provide the precise location of the wearable device to the contacted emergency service; and
notify a predefined group of recipients.

2. The emergency alert system of claim 1, wherein the biometric authentication module comprises a fingerprint scanner.

3. The emergency alert system of claim 1, wherein the emergency icons comprise a fire icon, a police icon, and a medical icon.

4. The emergency alert system of claim 1, wherein the location tracking module comprises a Global Positioning System (GPS) receiver.

5. The emergency alert system of claim 1, wherein the notification module is configured to send the confirmation alert via at least one of a visual, auditory, or haptic feedback.

6. The emergency alert system of claim 1, wherein the wearable device is further configured to provide the user's emergency contacts to the contacted emergency service.

7. The emergency alert system of claim 1, wherein the wearable device is a bracelet, a smartwatch, or a fitness tracker.

8. A method for alerting emergency responders comprising the steps of:
receiving, by a wearable device, biometric data from a user;
verifying, by the wearable device, the user's identity based on the received biometric data;
activating, by the wearable device, a plurality of emergency icons upon successful verification of the user's identity, each icon corresponding to a specific emergency service;
receiving, by the wearable device, a selection of an emergency icon;
determining, by the wearable device, a precise location of the wearable device;
contacting, by the wearable device, the emergency service corresponding to the selected emergency icon;
providing, by the wearable device, the precise location to the contacted emergency service; and
notifying, by the wearable device, a predefined group of recipients.

9. The method of claim 8, wherein the biometric data comprises a fingerprint.

10. The method of claim 8, wherein the emergency icons comprise a fire icon, a police icon, and a medical icon.

11. The method of claim 8, wherein determining the precise location of the wearable device comprises using a Global Positioning System (GPS).

12. The method of claim 8, further comprising sending, by the wearable device, a confirmation alert to the user upon contacting the emergency service.

13. The method of claim 12, wherein the confirmation alert is sent via at least one of a visual, auditory, or haptic feedback.

14. The method of claim 8, further comprising storing, the user's emergency contacts and biometric data.

15. The method of claim 14, wherein the user's emergency contacts and biometric data are stored in an encrypted format.

16. The method of claim 8, further comprising providing, by the wearable device, the user's emergency contacts to the contacted emergency service.

17. The method of claim 10, wherein the wearable device is a bracelet, a smartwatch, or a fitness tracker.
